(19) United States
(12) Patent Application Publication
(10) Pub. No.: US 2005/0127192 A1
(43) Pub. Date: Jun. 16, 2005

(54) Endpoint detector for a substrate manufacturing process

(76) Inventors: Hyun-Kyu Kang, Seoul (KR); No-Hyun Huh, Yongin-si (KR); Yong-Jin Kim, Suwon-si (KR); Kiw-Sang Kim, Suwon-si (KR); Seung-Ki Chae, Seoul (KR)

Correspondence Address: LEE & STERBA, P.C., SUITE 2000, 1101 WILSON BOULEVARD, ARLINGTON, VA, 22209, US

(21) Appl. No.: 11/010,299

(22) Filed: Dec. 14, 2004

(30) Foreign Application Priority Data
Dec. 15, 2003 (KR) 2003-91071

(51) Int. Cl. G05D 23/00; F25B 5/00; F28F 1/00; F25B 29/00

(52) U.S. Cl. 236/1 C; 236/91 A; 236/91 D; 165/253; 165/201

(57) ABSTRACT

An endpoint detector has a window, a first temperature control unit, a second temperature control unit and an analyzing unit. The window transmits light emitted from plasma in a processing chamber, and covers a passage through a sidewall of the processing chamber. The first temperature control unit maintains the window at a first temperature. The second temperature control unit maintains an inner surface of the passage at a second temperature, which is lower than the first temperature. The analyzing unit analyzes the light and determines an endpoint of a process in the processing chamber.

### BACKGROUND OF THE INVENTION

1. Field of the Invention

The present invention relates to a semiconductor manufacturing apparatus. More particularly, the present invention relates to an endpoint detector employed in the semiconductor manufacturing apparatus for detecting an endpoint of a semiconductor manufacturing process.

2. Description of the Related Art

Generally, manufacture of a semiconductor device, e.g., a random access memory (RAM), includes a fabricating step, an electrical die sorting step and a packaging step. In the fabricating step, an electric circuit is formed on a semiconductor substrate, e.g., a silicon wafer. In the electrical die sorting (EDS) step, the electrical characteristic of the electric circuit is inspected. In the packaging step, an epoxy resin encapsulates the electric circuit. If more than one semiconductor device is formed on the substrate, a die having the semiconductor device is separated from the substrate, e.g., by a sawing step.

In the fabricating step, a plurality of layers, e.g., a silicon dioxide layer, a polysilicon layer, an aluminum layer, and a copper layer, are formed on the silicon wafer. The layers may be formed by chemical vapor deposition (CVD), process, a physical vapor deposition (PVD) process, a thermal oxidation process, an ion implantation process and an ion diffusion process. The layers are selectively removed using etchant or plasma, thereby forming the electric circuit on the silicon wafer.

Most of the fabricating steps require in-situ monitoring of the electrical characteristics of various layers formed on the silicon wafer. Examples of in-situ monitoring include an optical emission spectroscopy (OES), an ellipsometry method, and an interferometry method.

An endpoint detector using the OES can monitor the thickness of the deposition film formed on the silicon wafer by the CVD process and the PVD process. Alternatively, the endpoint detector can monitor an overetching of the deposition film by the etchant or plasma.

An endpoint for the manufacturing process is determined based on the emission spectrum of the plasma, which is altered as the plasma reacts with the unprotected layers.

The endpoint detector for carrying out the OES includes a window for transmitting light emitted from plasma to an optical emission spectroscopy system. The window covers a view port formed on a sidewall of the process chamber. Typically, the window includes heat resistant quartz, which is also transparent to the wavelengths of interest in the emission spectrum.

The composition of the plasma is varied in accordance with the composition of the layers during etching of the layers formed on the silicon wafer. When the different layers formed on the silicon wafer are successively etched, the composition of plasma is varied. The emission spectrum of plasma varies in accordance with the composition of plasma. Thus, the endpoint of the etching is determined by the variation of the emission spectrum of plasma.

However, the plasma also creates a reaction product in the processing chamber. This reaction product is deposited on the surface of the window, resulting in a residue film. This residue film alters the intensity of the emission spectrum of plasma received by the OES, thereby interfering with the measurement of the emission spectrum of plasma.

### SUMMARY OF THE INVENTION

The present invention is therefore directed to an endpoint detector, which substantially overcomes one or more of the problems due to the limitations and disadvantages of the related art.

It is a feature of the present invention to provide an endpoint detector for preventing the deposition of the residue product on the surface of the monitoring window disposed on the processing chamber.

At least one of the above and other features and advantages of the present invention may be realized by providing an endpoint detector in a substrate processing, including a window covering a passage formed through a sidewall of a processing chamber in which the substrate processing is performed, the window transmitting light generated from plasma during the substrate processing, an analyzing unit for analyzing the light to detect an endpoint of the substrate processing, a first temperature control unit, thermally coupled to the window, for maintaining the window at a first temperature, and a second temperature control unit, thermally coupled to an inner surface of the passage, for maintaining the inner surface of the passage at a second temperature, the second temperature being lower than the first temperature.

The window may have a first surface that contacts an outer surface of the sidewall of the processing chamber and a second surface that is spaced apart from the processing chamber. The first temperature control unit may include a ceramic heater that makes contact with the second surface of the window. The ceramic heater may be ring shaped, and have an outer diameter that is substantially identical to a diameter of the window.

The endpoint detector may include a thermal sensor and a control part. The thermal sensor may measure a temperature of the window and/or the temperature of the heater. The control part controls an operation of the heater in accordance with a temperature signal output from the thermal sensor to maintain the first temperature of the window.

The second temperature control unit may include a coolant cycling channel, a coolant cycling pipe and a coolant cycling unit, wherein the coolant cycling channel is disposed around the passage, the coolant cycling channel controlling a temperature of the inner surface of the passage, the coolant cycling pipe is connected to the coolant cycling channel, and the coolant cycling unit circulates the coolant through the coolant cycling unit and the coolant cycling pipe. The second temperature control unit may be installed on the coolant cycling pipe, and the second temperature control unit includes a heat exchanger for transmitting a heat from the coolant that flows in the coolant cycling pipe. The endpoint detector may include an adiabatic member formed between the coolant cycling channel and an inside surface of the processing chamber.

The passage may include just a view port formed in the sidewall of a processing chamber, or may include a view port extender coupling the view port, the view port extender having a hole connecting to the view port. The second temperature control unit may wind around the view port extender, and the second temperature control unit may have a coolant passageway for cycling a coolant. The second temperature control unit may include a plurality of pins formed on the outer surface of the view port extender.

### BRIEF DESCRIPTION OF THE DRAWINGS

The above and other features and advantages of the present invention will become readily apparent to those of ordinary skill in the art by reference to the following detailed description when considered in conjunction with the accompanying drawings, in which:

FIG. 1 illustrates a schematic cross-sectional view of an end point detector according to a first embodiment of the present invention;

FIG. 2 illustrates an enlarged cross-sectional view of the end point detector shown in FIG. 1;

FIG. 3 illustrates an enlarged cross-sectional view of an endpoint detector according to a second embodiment of the present invention;

FIG. 4 illustrates an enlarged cross-sectional view of an endpoint detector according to a third embodiment of the present invention; and

FIG. 5 illustrates an enlarged cross-sectional view of an endpoint detector according to a fourth embodiment of the present invention.

### DETAILED DESCRIPTION OF THE INVENTION

Korean Patent Application No. 2003-91071, filed on Dec. 15, 2003, and entitled: “Endpoint Detector for a Substrate Manufacturing Process,” is incorporated by reference herein in its entirety.

The present invention now will be described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. In the drawings, the thickness of layers and regions are exaggerated for clarity. Like reference numerals refer to similar or identical elements throughout.

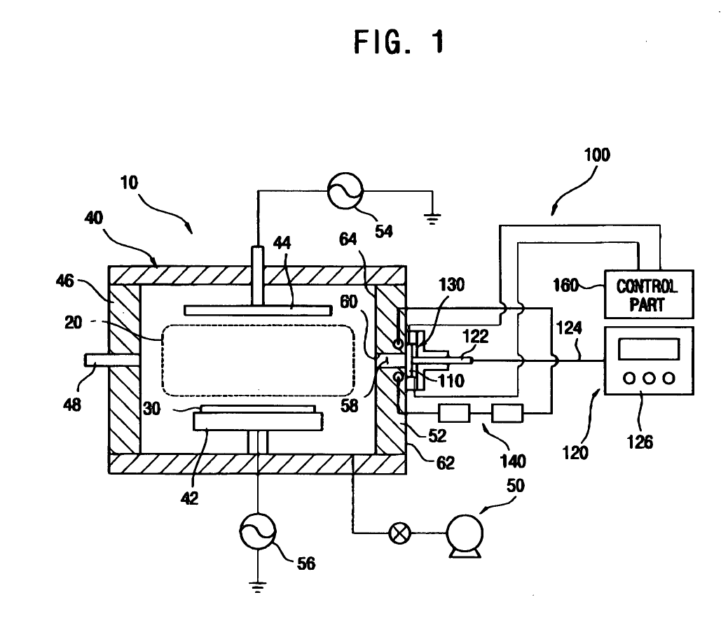

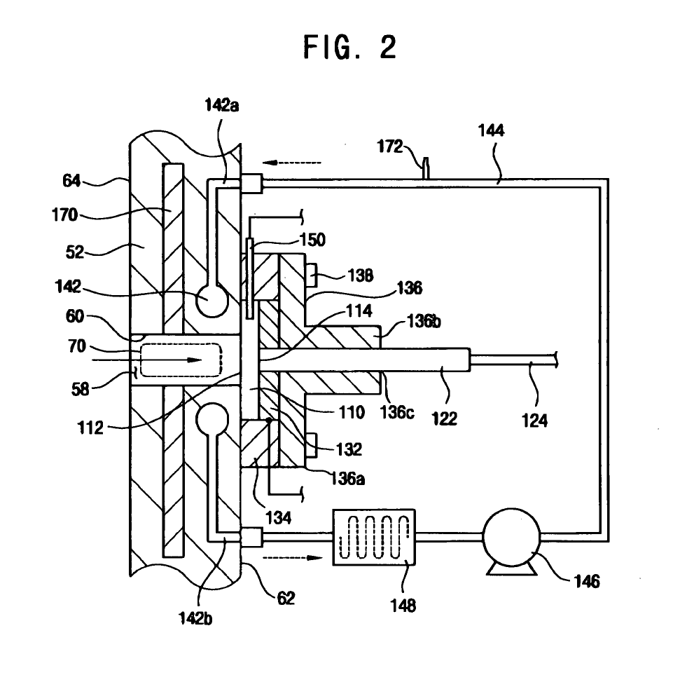

FIG. 1 illustrates a schematic cross-sectional view of an endpoint detector according to a first embodiment of the present invention. FIG. 2 illustrates an enlarged cross-sectional view of the endpoint detector shown in FIG. 1.

Referring to FIGS.1 and 2, an endpoint detector 100 is employed in a film processing device 10 for processing a silicon wafer 30 using plasma 20. The film processing device 10 may include, e.g., an etching device for patterning a variety of films formed on the silicon wafer 30 or an ashing device for removing a photo resist pattern or a photo resist film formed on the silicon wafer 30.

The film processing device 10 may include a processing chamber 40, a gas supply pipe 48, a vacuum system 50, a chuck 42, an upper electrode 44, a radio frequency power generator 54, and a bios power generator 56.

The processing chamber 40 provides a space for processing the silicon wafer 30, and includes a first sidewall 46 and a second sidewall 52. The chuck 42 is disposed in the processing chamber 40 for supporting the silicon wafer 30. The upper electrode 44 converts a reaction gas into the plasma 20. The gas supply pipe 48 is connected to the first sidewall 46 of the processing chamber 40, and supplies the reaction gas in the space of the processing chamber 40. The vacuum system 50 is connected to the bottom of the processing chamber 40 for creating a vacuum in the space of the processing chamber 40. The radio frequency power generator 54 is electrically coupled to the upper electrode 44 for generating the plasma 20 in the processing chamber 40, and the bios power generator 56 is electrically coupled to the chuck 42.

The endpoint detector 100 is disposed on the second sidewall 52 of the processing chamber 40. The endpoint detector 100 includes a window 110, an analyzing unit 120, a first temperature control unit 130, and a second temperature control unit 140.

The window 110 is disposed on an outer surface 62 of the second sidewall 52 of the processing chamber 40 to cover a view port 58 formed in the second sidewall 52. The window 110 includes a first surface 112 and a second surface 114. The first surface 112 is disposed on the outer surface 62 of the second sidewall 52 corresponding to the view port 58, and the second surface 114 is opposite the first surface 112. The window 110 may be made of transparent, heat resistant quartz and may have a disc shape.

The first temperature control unit 130 controls a temperature of the window 110. The first temperature control unit 130 is disposed on the second surface 114 of the window 110. The first temperature control unit 130 includes a heater, e.g., a ceramic heater 132, for heating the window 110 to a first temperature. The first temperature of the window 110 may be maintained between about 10° C. and 20° C. by the ceramic heater 132. The ceramic heater 132 may have a ring shape and a rectangular cross-section. The outer diameter of the ceramic heater 132 may be the same as the outer diameter of the window 110.

The window 110 and the ceramic heater 132 may be mounted on the second sidewall 52 of the processing chamber 40 by an adapter 136 and a window holder 134.

The window holder 134 may have the same shape as the ceramic heater 132, here a ring shape with a rectangular cross-section. The inner diameter of the window holder 134 may be the same as that of an outer diameter of the window 110 and the ceramic heater 132. The window holder 134 may be disposed on sides of the window 110 and the ceramic heater 132 to grip the window 110 and the ceramic heater 132.

The adapter 136 may have a flange shape, and the adapter 136 fixes the window 110 and the ceramic heater 132 to the second sidewall 52 by a fixing member 138. The fixing member 138 passes through the adapter 136 and the window holder 134. In this exemplary embodiment, the fixing member 138 includes a plurality of bolts.

The adapter 136 may include a first part 136a, a second part 136b and a hole 136c. The first part 136a is disposed on the ceramic heater 132 and the window holder 134. The first part may have a ring shape and a rectangular cross-section. The second part 136b is disposed on the first part 136a, and may have a cylindrical shape that extends in a perpendicular direction to the first part 136a. The hole 136c passes through the first part 136a and the second part 136b, and extends parallel to the second part 136b.

The analyzing unit 120 includes an optical probe 122, an optical cable 124 and an optical emission spectrometer 126. The optical probe 122 may be disposed in the hole 136c of the adapter 136 so that the optical probe 122 contacts a central portion of the second surface 114 of the window 110.

The optical cable 124 connects the optical probe 122 and the optical emission spectrometer 126. The optical emission spectrometer 126 analyzes an emission spectrum of plasma input through the view port 58 of the process chamber 40, the window 110, the optical probe 122, and the optical cable 124, and calculates the endpoint from the spectrum of the plasma.

The second temperature control unit 140 includes a coolant cycling channel 142, a coolant cycling pipe 144 and a cycling unit 146.

The coolant cycling channel 142 controls a temperature of the inner surface 60 of the view port 58, and is disposed around the view port 58 formed in the second sidewall 52 of the process chamber 40. The coolant cycling channel 142 includes a coolant that flows through the coolant cycling channel 142.

The coolant cycling pipe 144 connects an inlet port 142a and an outlet port 142b. The coolant cycling pipe 144 may include a heat exchanger 148 for transferring heat from the coolant that flows through the coolant cycling pipe 144.

The cycling unit 146 for cycling the coolant through the coolant cycling channel 142 and the coolant cycling pipe 144 is installed in the coolant cycling pipe 144. The cycling unit 146 includes a pump that controls flow of the coolant. Arrows adjacent to the inlet port 142a and the outlet port 142b in FIG. 2, indicate a cycling direction of the coolant. The coolant flowing through the coolant cycling pipe 144 may include a nitrogen N₂ gas, a helium (He), gas and cooling water.

The second temperature control unit 140 maintains the temperature of the inner surface 60 of the view port 58 of the process chamber 40 at a second temperature, which is lower than the first temperature. In this exemplary embodiment, a difference between the first and second temperatures may be more than about 10° C.

Light emitted from the plasma generated in the process chamber 40 transmits through the view port 58, the window 110, the optical probe 122, and the optical cable 124 to the optical emission spectrometer 126. The intensity of the light generated from the plasma is changed in accordance with the plasma etching in the process chamber 40.

The optical emission spectrometer 126 measures the light in the emission spectrum of the plasma and calculates the endpoint of the etching process in accordance with the variation of the spectrum.

However, a reaction residue product is also generated in the process chamber 40 by the reaction between the layer formed on the silicon wafer 30 and the plasma in the processing chamber 40. When the reaction residue product is deposited on the first surface 1 12 of the window 110, a thin residue film is formed on the first surface 112 of the window 110, interfering with the transmission of the emission spectrum. For example, a residue film including carbon fluoride (CFx) reaction residue product absorbs ultraviolet light having a wavelength less than 400 nm, which is of interest in determining the endpoint for that particular process.

Deposition of the reaction residue product on the first surface 112 of the window 110 will be described from a thermophoresis point of view. “Thermophoresis” means that the diffusion of the impurities onto different objects depends on a temperature deviation between the objects. Thermophoresis affects the movement of the impurities having a size between about 0.1 μm and about 1 μm.

Generally, when the temperature deviation occurs between a high temperature object and a low temperature object, the impurities included in a surrounding medium move from the high temperature region to the low temperature region, thereby forming a clean region around the high temperature object. The area of the clean region is determined in accordance with both temperature and pressure. For example, increasing the temperature and decreasing the pressure of the high temperature object will enlarge the area of the clean region. Meanwhile, the impurities attach to the low temperature object due to themophoresis.

In an exemplary embodiment, an inner temperature of the processing chamber 40 is higher than the temperature of the sidewalls 46, 52, and the temperature of the window 110 is higher than or equal to the temperature of the sidewalls 46, 52.

The first temperature control unit 130 maintains the window 110 at a higher temperature than that of the inner region 70 of the view port 58 and the inner surface 60 of the view port 58. The second temperature control unit 140 maintains the inner surface 60 at a lower temperature than that of the inner region 70 of the view port 58.

Thus, the clean region formed adjacent first surface 112 of the window 110 is enlarged by the temperature deviation formed between the process chamber 40 and the window 110, so that the reaction residue products are deposited on the inner surface 60 of the view port 58. Thus, the endpoint detector precisely monitors the spectrum of the plasma generated in the processing chamber 40, improving the accuracy of endpoint detection.

The endpoint detector 100 further includes a temperature sensor 150 for measuring the temperature of the window 110, and a control part 160 for controlling the ceramic heater 132 in accordance with the temperature signal output from the temperature sensor 150, in order to maintain the first temperature of the window 110. In this exemplary embodiment, the temperature sensor 150 may include a thermocouple and/or a thermister.

The control part 160 includes a control circuit (not shown) and a power supply module (not shown). The control circuit generates a control signal according to the temperature of the window 110 output by the temperature sensor 150. The power supply module controls a level of the power supplied to the ceramic heater 132 in accordance with the control signal.

Alternatively, the temperature sensor 150 may measure a temperature of the ceramic heater 132. Thus, the control part 160 may control the temperature of the window 110 via the temperature of the ceramic heater 132.

The endpoint detector 100 may include a temperature sensor 172 for measuring the temperature of the coolant that flows in the coolant cycling pipe 144. The control part 160 may control the cycling unit 146 in accordance with a coolant temperature output by the temperature sensor 172.

Alternatively, the endpoint detector 100 the temperature sensor 172 may directly measure the temperature of the inner surface 60 of the view port 58. The temperature sensor 172 would then be disposed near the inner surface 60 of the view port 58. The control part 160 may control the cycling unit 146 in accordance with a temperature of the inner surface 60 output by the temperature sensor 172.

Then, the control part 160 may compare the temperature of the window 110 that is measured by the temperature sensor 150 with the temperature of the inner surface 60 of the view port 58 that is measured by the temperature sensor 172, so that the operation of the ceramic heater 132 and the cycling unit 146 can be precisely controlled in accordance with the comparison result data. Hence, the window 110 is maintained at a higher temperature than that of the inner surface 60 of the view port 58.

The endpoint detector 100 may further include an adiabatic member 170 interposed between the coolant cycling channel 142 and an inner surface 64 of the second sidewall 52 of the processing chamber 40. The adiabatic member 170 may have a ring shape, and encapsulates the view port 58 in order to thermally isolate the coolant cycling channel 142 and the inner surface 64 of the second sidewall 52. Thus, the adiabatic member 170 prevents heat exchange between the processing chamber 40 and the coolant.

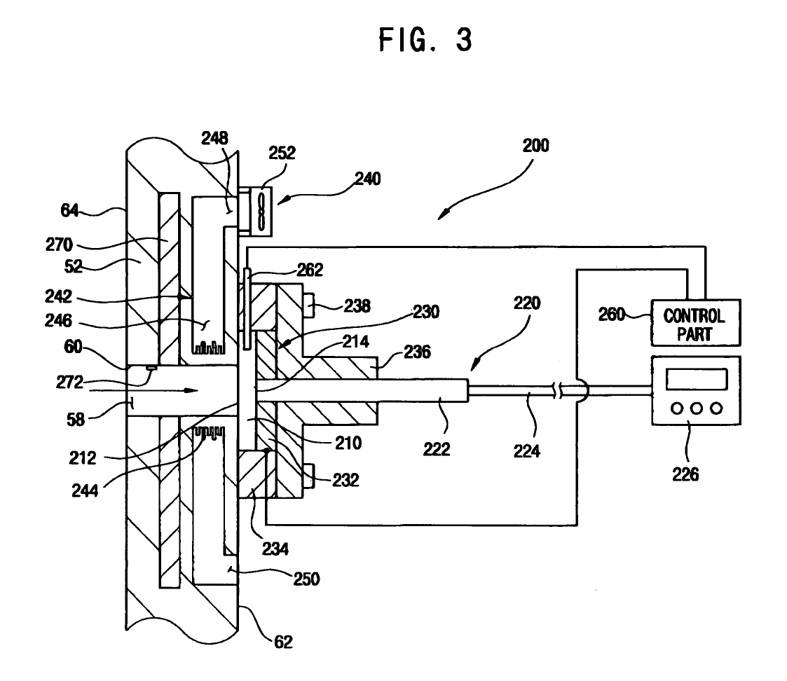

FIG. 3 illustrates an enlarged cross-sectional view of an endpoint detector according to a second embodiment of the present invention.

Referring to FIG. 3, the endpoint detector 200 is combined with the semiconductor manufacturing device. For example, the semiconductor manufacturing device may include a processing chamber for performing a plasma etching, a chuck for supporting a semiconductor substrate such as a silicon wafer, an upper electrode for generating plasma in the processing chamber, as set forth above in connection with FIG. 1. Again, the endpoint detector 200 is connected to the second sidewall 52 of the processing chamber.

The endpoint detector 200 includes a window 210, an analyzing unit 220, a first temperature control unit 230 and a second temperature control unit 240.

In order to transmit the light emitted from the plasma in the processing chamber, the window 210 is disposed on the outer surface 62 of the second sidewall 52 of the processing chamber to cover the view port 58 formed in the second sidewall 52 of the processing chamber. The window 210 may have a disc shape, and the window 210 is disposed on the second sidewall 52 of the processing chamber. The window 210 includes a first surface 212 that contacts the outer surface 62 of the second sidewall 52, and a second surface 214, opposite the first surface 212.

The analyzing unit 220 analyzes the light transmitted through the window 210. The analyzing unit 220 includes an optical probe 222 connected to a central portion of the second surface 214 of the window 210, an optical emission spectrometer 226 for analyzing the light generated in the process chamber, and an optical cable 224 for connecting the optical probe 222 and the optical emission spectrometer 226.

The first temperature control unit 230 heats the window 210 to a first temperature. The first temperature control unit 230 may include a ceramic heater 232 disposed on the second surface 214 of the window 210 in order to heat the window 210.

The second temperature control unit 240 is formed in the second sidewall 52 of the processing chamber, and surrounds the view port 58 of the processing chamber. The second temperature control unit 240 includes a cooling channel 242 connected to outside the processing chamber. The cooling channel 242 cools the inner surface 60 of the view port 58 using air external to the processing chamber, so that the temperature of the inner surface 60 of the view port 58 is maintained at a second temperature. In this exemplary embodiment, the second temperature is lower than the first temperature.

The cooling channel 242 may include a plurality of cooling pins 244 for radiating heat from the inner surface 60 of the view port 58. The cooling pins 244 may be disposed adjacent to the inner surface 60 of the view port 58.

The cooling channel 242 also includes a cooling portion 246, an inlet port 248 and an exhaust port 250. The cooling portion 246 is formed in the second sidewall 52 of the process chamber. The cooling portion 246 may have a ring shape and a rectangular cross-section. The cooling portion 246 is disposed around the view port 58.

Cooling air is input through the inlet port 248 and is output through the exhaust port 250. The cooling air cools the cooling pins 244, which in turn cool the view port 58.

The second temperature control unit 240 may include a cooling fan 252. The cooling fan 252 is disposed at the inlet port 248, and provides the cooling air to the cooling channel 242. Alternatively, the cooling fan 252 may be disposed at the exhaust port 250, and removes the cooling air from the cooling channel 242. Alternatively, the second temperature control unit 240 may include a plurality of inlet openings to provide the cooling air to the cooling channel 242 and may include a plurality of outlet openings to exhaust the cooling air from the cooling channel 242.

A window holder 234, an adapter 236 and a plurality of the fixing members 238 secure the window 210 and the ceramic heater 232 to the second sidewall 52 of the processing chamber. A control part 260 controls the operation of the ceramic heater 232 in accordance with the temperature of the window 210 that measured by a temperature sensor 262.

The endpoint detector 200 may further include an adiabatic member 270 that prevents heat exchange between the inner surface 64 of the processing chamber and the second temperature control unit 240. The endpoint detector 200 may include a temperature sensor 272 for measuring the temperature of the inner surface 60 of the view port 58. The control part 260 compares the temperature of the window 210 that is measured by the temperature sensor 262 with the temperature of the inner surface 60 of the view port 58 that is measured the temperature sensor 272, to precisely control the operation of the ceramic heater 232. Thus, the temperature of the inner surface 60 of the view port 58 may be maintained below that of the temperature of the window 210 by the second temperature control unit 240. Therefore, the reaction residue products generated in the processing chamber are deposited on the inner surface 60 of the view port 58, rather than the window 210.

As it is described above, the light generated from the plasma is transmitted through the window 210 to the optical emission spectrometer 226 without decreasing the intensity of the light, increasing accurate endpoint detection.

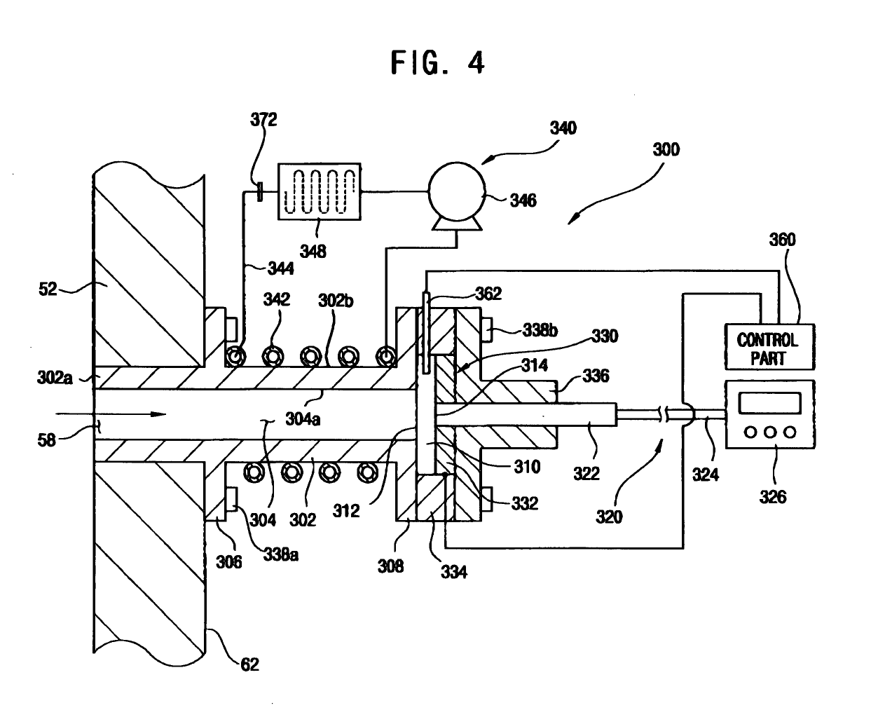

FIG. 4 illustrates an enlarged cross-sectional view of an endpoint detector according to a third embodiment of the present invention.

Referring to FIG. 4, the endpoint detector 300 is combined with the semiconductor manufacturing device. For example, the semiconductor manufacturing device includes a processing chamber for performing a plasma etching, a chuck for supporting a semiconductor substrate such as a silicon wafer, an upper electrode for generating plasma in the processing chamber, as set forth above in connection with FIG. 1.

The endpoint detector 300 includes a view port extender 302 for extending a view port 58 in the second sidewall 52 of the process chamber, a window 310, an analyzing unit 320, a first temperature control unit 330, and a second temperature control unit 340.

The view port extender 302 for extending the view port 58 formed in the second sidewall 52 of the processing chamber may have a cylindrical shape, and connects the view port 58 formed in the sidewall of the process chamber to the window 310. The view port extender 302 has a hole 304, and an axis of the hole 304 is identical to an axis of the view port 58.

The view port extender 302 includes a first lateral part 302a, a second lateral part 302b, a first flange 306 and a second flange 308.

The first lateral part 302a is inserted into the view port 58. The first flange 306 is disposed on the adjacent portion of the first lateral part 302a and contacts the outer surface 64 of the second sidewall 52 of the process chamber. The second lateral part 302b extends from the first flange 306 to the second flange 308, which, in turn, contacts the window 310.

The window 310 for transmitting the light generated from the plasma may have a disc shape and may be made of a transparent material such as quartz. The window 310 is disposed on the second flange 308 to cover the hole 304 of the view port extender 302.

The window 310 has a first surface 312 and a second surface 314, opposite the first surface 312. The first surface 312 contacts the second flange 308 of the view port extender 302.

The first temperature control unit 330 controls the temperature of the window 310 to reach a first temperature. The first temperature control unit 330 may have a ring shape and may include a ceramic heater 332 disposed on the second surface 314 of the window 310. The ceramic heater 332 is electrically connected to a control part 360, and the control part 360 is electrically connected to a temperature sensor 362 for measuring the temperature of the window 310.

The control part 360 controls the operation of the ceramic heater 332 in accordance with a temperature signal output from the temperature sensor 362 to maintain the window 310 at the first temperature.

The analyzing unit 320 analyzes the light transmitted through the window 310 in order to detect the endpoint of the etching process processed in the processing chamber.

The analyzing unit 320 includes an optical probe 322, an optical cable 324 and an optical emission spectrometer 326. The optical probe 322 is connected to a central portion of the second surface 314 of the window 310. The optical cable 324 extends from the optical probe 322 to the emission spectrometer 326.

The emission spectrum of the plasma is successively transmitted from the processing chamber to the optical emission spectrometer 326 via the view port 58 of the processing chamber, the hole 304 of the view port extender 302, the window 310, the optical probe 322 and the optical cable 324.

The optical emission spectrometer 326 analyzes the light generated from the processing chamber to determine the endpoint of the etching process.

A plurality of the first fixing members 338a secures the view port extender 302 to the second sidewall 52 of the processing chamber through the first flange 306. A plurality of the second fixing member 338b secures the window 310 and the ceramic heater 332 to the view port extender 302 through the second flange 308, the window holder 334 and an adapter 336.

The temperature of an inner surface 304a of the hole 304 of the view port extender 302 is maintained at a second temperature by the second temperature control unit 340. In this embodiment, the second temperature is lower than the first temperature.

The second temperature control unit 340 includes a cooling coil 342 wound around the view port extender 302. A cooling coil 342 has a passageway that circulates a coolant. The cooling coil 342 is connected to a coolant cycling pipe 344. A cycling unit 346 for cycling the coolant in the coolant cycling pipe 344 and a heat exchanger 348 for radiating the heat to the coolant cycled in the coolant cycling pipe 344 are connected to the coolant cycling pipe 344. In this embodiment, the coolant may include a nitrogen gas, a helium gas or cooling water.

The endpoint detector 300 may include a second temperature sensor 372 for measuring the temperature of the coolant that flows in the coolant cycling pipe 344. The output of the second temperature sensor 372 is provided to the control part 360. The control part 360 controls the operation of the cycling unit 346 to control an amount of coolant in accordance with the temperature of the coolant measured by the second temperature sensor 372.

Alternatively, the second temperature sensor 372 may be mounted adjacent to the inner surface 304a of the view port extender 302, in order to directly measure the temperature of the inner surface 304a of the view port extender 302.

The temperature of the inner surface 304a of the view port extender 302 is maintained at the second temperature, which is lower than the first temperature of the window 310. Thus, the reaction residue products from the plasma are deposited on the inner surface 304a of the view port extender 302, rather than the window 310 or elsewhere in the optical path between the processing chamber and the spectrometer.

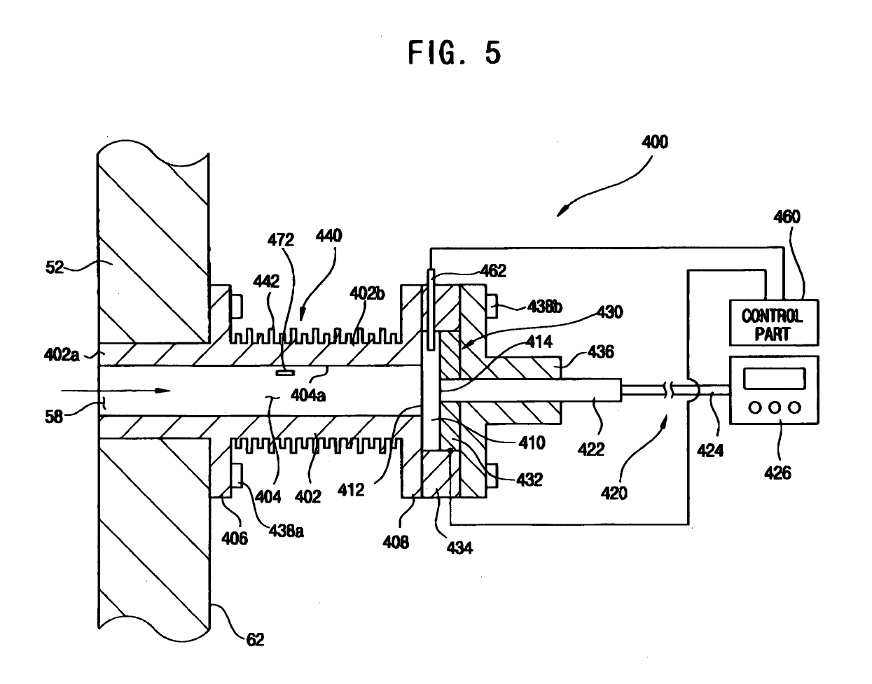

FIG. 5 illustrates an enlarged cross-sectional view of an endpoint detector according to a fourth embodiment of the present invention.

Referring to FIG. 5, an endpoint detector 400 is combined with the semiconductor manufacturing device. For example, the semiconductor manufacturing device includes a processing chamber for performing a plasma etching, a chuck for supporting a semiconductor substrate such as a silicon wafer, an upper electrode for generating plasma in the processing chamber, as set forth above in connection with FIG. 1.

The endpoint detector 400 includes a view port extender 402 for extending the view port 58 in the second sidewall 52 of the process chamber, a window 410, an analyzing unit 420, a first temperature control unit 430, and a second temperature control unit 440.

The view port extender 402 for extending the view port 58 formed in the second sidewall of the processing chamber may have a cylindrical shape, and connects the view port 58 to the window 410. The view port extender 402 has a hole 404, and an axis of the hole is identical to an axis of the view port 58.

The view port extender 402 includes a first lateral part 402a, a second lateral part 402b, a first flange 406 and a second flange 408.

The first lateral part 402a is inserted into the view port 58. The first flange 406 is disposed on the adjacent portion of the first lateral part 402a and contacts the outer surface 64 of the second sidewall 52 of the process chamber. The second lateral part 402b extends from the first flange 406 to the second flange 408, which, in turn, contacts the window 410.

The window 410 for transmitting the light generated from the plasma may have a disc shape and be made of a transparent material such as quartz. The window 410 is disposed on the second flange 408 to cover the hole 404 of the view port extender 402.

The window 410 has a first surface 412 and a second surface 414, opposite the first surface 412. The first surface 412 contacts the second flange 408 of the view port extender 402.

The temperature control unit 430 controls the temperature of the window 410 to reach a first temperature. The temperature control unit 430 may have a ring shape and the may include a ceramic heater 432 disposed on the second surface 414 of the window 410. The ceramic heater 432 is electrically connected to a control part 460, and the control part 460 is electrically connected to a first temperature sensor 462 for measuring the temperature of the window 410.

A plurality of the first fixing members 438a secures the view port extender 402 to the second sidewall 52 of the processing chamber through the first flange 406. A plurality of the second fixing members 438b secures the window 410 and the ceramic heater 432 to the view port extender 402 through the second flange 408, the window holder 434 and an adapter 436.

The temperature control part 440 includes a plurality of cooling pins 442 formed on the outer surface of the view port extender 402. The cooling pins 442 are formed between the first flange 406 and the second flange 408, and may have a ring shape. In this embodiment, each of the cooling pins may have a cylinder shape, a hemisphere shape, or a bar shape that extends perpendicular to the view port extender 402.

The control part 460 controls the operation of the ceramic heater 432 in accordance with a temperature of the window 410 that is measured to the first temperature sensor 462.

The endpoint detector 400 may include a second temperature sensor 472 for measuring the temperature of the inner surface 404a of the view port extender 402.

The control part 460 compares the temperature of the window 410 with the temperature of the inner surface 404a of the view port extender 404 to maintain the window 410 at a higher temperature than the inner surface 404a of the view port extender 404.

The endpoint detector may include a fan unit for supplying cooling air to the surfaces of the cooling pins 442.

The analyzing unit 420 analyzes the light transmitted through the window 410 in order to detect the endpoint of the etching process processed in the processing chamber.

The analyzing unit 420 includes an optical probe 422, an optical cable 424 and an optical emission spectrometer 426. The optical probe 422 is connected to a central portion of the second surface 414 of the window 410. The optical cable 424 extends from the optical probe 422 to the optical emission spectrometer 426.

The light emitted from the plasma is successively transmitted from the processing chamber to the optical emission spectrometer 426 via the view port 58 of the processing chamber, the hole 404 of the view port extender 402, the window 410, the optical probe 422 and the optical cable 424.

The optical emission spectrometer 426 analyzes the light generated from the processing chamber so that the endpoint of the etching process is detected.

Thus, in accordance with the present invention, by maintaining a window at a first temperature and an inner surface of a passage between a processing chamber and the window at a second temperature, any resultant reaction residue is deposited on the inner surface, rather than the window, thus being removed from the transmission path to the analyzing unit.

Exemplary embodiments of the present invention have been disclosed herein and, although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

1. An apparatus for detecting an endpoint in a substrate processing, comprising:
a window covering a passage formed through a sidewall of a processing chamber in which the substrate processing is performed, the window transmitting light generated from plasma during the substrate processing;
an analyzing unit for analyzing the light to detect an endpoint of the substrate processing;
a first temperature control unit, thermally coupled to the window, for maintaining the window at a first temperature; and
a second temperature control unit, thermally coupled to an inner surface of the passage, for maintaining the inner surface of the passage at a second temperature, the second temperature being lower than the first temperature.

2. The apparatus as claimed in claim 1, wherein the window has a first surface that contacts an outer surface of the sidewall of the processing chamber and a second surface that is spaced apart from the processing chamber.

3. The apparatus as claimed in claim 2, wherein the first temperature control unit includes a ceramic heater that makes contact with the second surface of the window.

4. The apparatus as claimed in claim 3, wherein the ceramic heater is ring shaped, and an outer diameter of the ceramic heater is substantially identical to a diameter of the window.

5. The endpoint detector as claimed in claim 4, wherein the analyzing unit is disposed on the second surface of the window, and the analyzing unit extends through an inner surface of the ceramic heater.

6. The endpoint detector as claimed in claim 4, wherein the endpoint detector further comprises a window holder, an adapter and a fixing member, wherein the window holder grips the outer diameter of the window and an outer diameter of the ceramic heater, the adapter secures the window holder and the ceramic heater, and the fixing member secures the adapter, the ceramic heater and the window holder to the sidewall of the processing chamber.

7. The endpoint detector as claimed in claim 1, wherein the analyzing unit further comprises an optical probe, an optical emission spectrometer and an optical cable, wherein the optical probe is in communication with a center portion of the second surface of the window, the optical cable connects the optical probe to optical emission spectrometer, and the optical emission spectrometer analyzes the light to detect the endpoint of the process.

8. The endpoint detector as claimed in claim 3, wherein the endpoint detector further comprises a thermal sensor and a control part, wherein the thermal sensor measures a temperature of the window and the control part controls an operation of the ceramic heater in accordance with a temperature signal output from the thermal sensor to maintain the first temperature of the window.

9. The endpoint detector as claimed in claim 3, wherein the endpoint detector further comprises a thermal sensor and a control part, wherein the thermal sensor measures a temperature the ceramic heater and the control part controls an operation of the ceramic heater in accordance with a temperature signal output from the thermal sensor to maintain the first temperature of the window.

10. The endpoint detector as claimed in claim 1, wherein the second temperature control unit further comprises a coolant cycling channel, a coolant cycling pipe and a coolant cycling unit, wherein the coolant cycling channel is disposed around the passage, the coolant cycling channel controlling a temperature of the inner surface of the passage, the coolant cycling pipe is connected to the coolant cycling channel, and the coolant cycling unit circulates the coolant through the coolant cycling unit and the coolant cycling pipe.

11. The endpoint detector as claimed in claim 10, wherein the coolant includes a nitrogen gas, a helium gas or cooling water.

12. The endpoint detector as claimed in claim 10, wherein the second temperature control unit is installed on the coolant cycling pipe, and the second temperature control unit includes a heat exchanger for transmitting a heat from the coolant that flows in the coolant cycling pipe.

13. The endpoint detector as claimed in claim 10, wherein the endpoint detector further comprises an adiabatic member formed between the coolant cycling channel and an inside surface of the processing chamber.

14. The endpoint detector as claimed in claim 1, wherein the second temperature control unit further comprises a cooling channel for controlling a temperature of the inner surface of the passage, the cooling channel being formed around the view port and the cooling channel is connected to outside the processing chamber.

15. The endpoint detector as claimed in claim 15, wherein the cooling channel further comprises a plurality of cooling pins formed in the cooling channel.

16. The endpoint detector as claimed in claim 15, wherein the cooling channel further comprises a cooling region having a ring shape, an inlet port and an outlet port, wherein the cooling region is disposed around the passage, the inlet port introduces external air to the cooling region, the outlet port exhausts the external air.

17. The endpoint detector as claimed in claim 16, wherein the cooling channel further comprises a fan supplying the external air to the cooling region.

18. The endpoint detector as claimed in claim 14, wherein the cooling channel further comprises a cooling region having a ring shape and a plurality of openings for connecting the cooling region and to outside the processing chamber.

19. The endpoint detector as claimed in claim 1, wherein the passage comprises a view port extender coupling a view port formed in the sidewall of a processing chamber, the view port extender having a hole connecting to the view port.

20. The endpoint detector as claimed in claim 19, wherein the second temperature control unit winds around the view port extender, and the second temperature control unit has a coolant passageway for cycling a coolant.

21. The endpoint detector as claimed in claim 19, wherein the second temperature control unit includes a plurality of pins formed on the outer surface of the view port extender.

22. The endpoint detector as claimed in claim 1, wherein the passage comprises a view port formed in the sidewall.
